(19) United States
(12) Patent Application Publication
(10) Pub. No.: US 2012/0009477 A1
(43) Pub. Date: Jan. 12, 2012

(54) Anode material of rapidly chargeable lithium battery and manufacturing method thereof

(75) Inventors: Jin-Ming Chen, Taoyuan County (TW); Yen-Po Chang, Changhua County (TW); Shih-Chieh Liao, Taoyuan County (TW); Yu-Min Peng, Hsinchu City (TW); Chi-Ju Cheng, Hsinchu County (TW); Meng-Lun Lee, Hsinchu County (TW)

(73) Assignee: Industrial Technology Research Institute, Hsinchu (TW)

(21) Appl. No.: 12/924,526

(22) Filed: Sep. 28, 2010

(30) Foreign Application Priority Data
Jul. 12, 2010 (TW) 99122863

(51) Int. Cl. H01M 4/46; B05D 5/12; H01M 4/26; H01M 4/505; H01M 4/583

(52) U.S. Cl. 429/224; 429/231.1; 429/231.8; 427/77

(57) ABSTRACT

An anode material of rapidly chargeable lithium battery and a manufacturing method thereof are provided. The anode material includes a carbon core and a modification layer. The modification layer is formed on a surface of the carbon core by sol-gel method. This modification layer is a composite lithium metal oxide represented by the formula Li₄M₅O₁₂-MOₓ, wherein M represents Ti or Mn, and 1≦x≦2.

### CROSS-REFERENCE TO RELATED APPLICATION

This application claims the priority benefit of Taiwan application serial no. 99122863, filed on Jul. 12, 2010. The entirety of the above-mentioned patent application is hereby incorporated by reference herein and made a part of this specification.

### BACKGROUND

1. Technical Field

The disclosure relates to an anode material of a rapidly chargeable lithium-ion battery.

2. Background

Lithium-ion battery is largely applied in notebook computers, mobile phones, digital cameras, video cameras, PDAs, bluetooth and wireless 3C products. However, in the application of electric vehicles and hand tools that demand high power, lithium-ion battery is not yet sophisticated enough. Electric vehicles are one of the most important industrial products in this century, and lithium-ion battery is the priority choice of power for electric vehicles. For the application lithium-ion battery in the field of electric vehicles, for example, rapid charging of battery is the most challenging problem that requires an imminent solution.

Currently, the anode material of a lithium-ion battery is graphite (or also known as “Measocarbon micro beads”, MCMB), which has high electrical conductivity, stable capacity and electric discharge characteristics. However, a lithium-ion battery using graphite as the anode material lacks the rapid charging capability due to the polarization phenomenon on the surface of the MCMB electrode, such as charge transfer reaction, diffusion capability of lithium ions in an active material, electron conduction, electron transport in electrolyte, and the generation of a solid electrolyte interface (SEI) film on the surface of graphite, which would hinder the lithium ions to rapidly enter into internal part of the anode material.

Accordingly, recent research is directed to using a spinel-type lithium metal oxide material (such as, Li₄Ti₅O₁₂, LTO) as a shell layer to cover the surface of the graphite anode material, as disclosed in WO2009061013. Although externally adding a shell layer on the graphite anode material may allow a rapid discharge, the problem of low electrical conductivity in lithium metal oxide material remains.

### SUMMARY

A lithium-ion battery anode material is introduced herein. The anode material is capable of rapid charging to increase conductivity.

A fabrication method of a lithium-ion battery anode material is introduced herein. In the method, an anode material is formed that contains a composite lithium metal oxide material as a modification layer.

The disclosure provides a lithium battery anode material that includes a carbon core and a modification layer. The modification layer is formed on the surface of the carbon core via a sol-gel method. The modification layer is a composite lithium metal oxide material represented by a formula of Li₄M₅O₁₂-MOₓ, wherein M is titanium (Ti) or manganese (Mn), and 1≦x≦2.

The disclosure yet provides a fabrication method of a lithium ion battery anode material, in which a carbon material is used to fabricate a core. Then, a modification layer is formed on the surface of the above-mentioned core, followed by performing a calcining step. The above modification layer is a lithium metal oxide material represented by a formula of Li₄M₅O₁₂-MOₓ, wherein, M is Ti or Mn, and 1≦x≦2.

According to one exemplary embodiment of the disclosure, a sol-gel method is applied to modify the surface of the carbon core to a Li₄M₅O₁₂-MOₓ type composite lithium metal oxide material. Since lithium metal oxide material can obviate the generation of a SEI film during the charging and discharging processes and comprises zero-strain and a three dimensional (3D) crystalline structure, the generation of a SEI film that is normally observed on the surface of a carbon material is suppressed. Hence, by reducing the generation of the SEI film that often occurs on the surface of a carbon material, lithium ions may rapidly enter into the carbon material through the composite lithium metal oxide material to achieve the rapid charging characteristic. Moreover, the modification layer in the disclosure is doped with a small amount of metal suboxide that has semiconductor characteristic; hence, the electric conductivity of the lithium oxide material is enhanced so as to provide the graphite (i.e. carbon core) with low potential and stable capacity in this disclosure for a high current charging capability.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic, cross-sectional view diagram illustrating an anode material of a lithium battery according to an exemplary embodiment of the disclosure.

FIG. 2 is a schematic, cross-sectional view diagram illustrating another anode material of the lithium battery of the exemplary embodiment of the disclosure.

FIGS. 3A and 3B are schematic diagrams of the modification layer in the exemplary embodiment respectively.

FIG. 4 is a graph showing the differences in the powder X-ray diffraction characteristics of the MCMB powders before and after being modified.

FIG. 5A is a photograph of scanning electron microscope (SEM) of MCMB 1028.

FIG. 5B is a photograph of scanning electron microscope (SEM) of Experiment 1 that shows the surface appearance of MCMB after being modified.

FIG. 6 is a photograph of transmission electron microscope (TEM) of the LTO—TiO₂/MCBC composite material of Experiment 1.

FIG. 7 is a photograph of selected area electron diffraction (SAED) of the LTO—TiO₂ material in FIG. 6.

FIG. 8A is a graph showing the charging and discharging curves of the comparative example (non-modified MCMB).

FIG. 8B is a graph showing the charging and discharging curves of the sample of Experiment 2 (modified MCMB).

FIG. 9 is a graph showing the difference in capacity between the comparative example (non-modified MCMB) and the sample of Experiment 1 (post-modified MCMB) under different current rates (C-rate).

FIG. 10 is a graph showing the difference in capacity between the modified MCMB battery and the non-modified MCMB battery under different discharging current rates.

FIG. 11 is a graph showing the cycle life of a lithium battery of Experiment 2 under different charging and discharging current rates.

### DESCRIPTION OF EMBODIMENTS

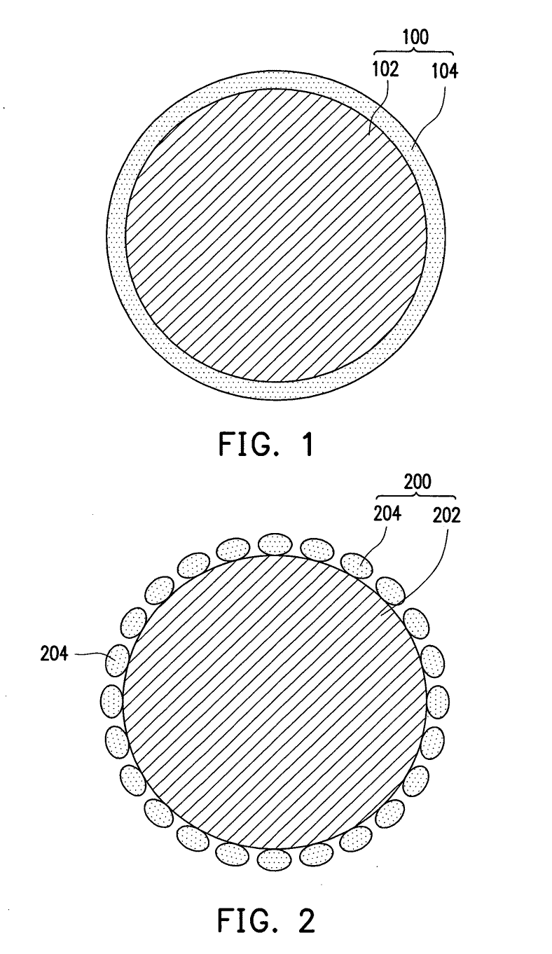

FIG. 1 is a schematic, cross-sectional view diagram illustrating an anode material of a lithium battery according to an exemplary embodiment of the disclosure.

Referring to FIG. 1, the anode material 100 of a lithium battery in this exemplary embodiment of the disclosure includes a carbon core 102 and a modification layer 104, wherein the modification layer 104 is formed by a sol-gel method on the surface of the carbon core. As illustrated in FIG. 1, the modification layer 104 is a thin film layer inlayed in the surface of the carbon core 102. Alternatively speaking, there is a bonding between the modification layer 104 and the carbon core 102, and the coverage of the carbon core 102 by the modification layer 104 is 100%. The content of the above modification layer 104 is, for example, about 0.1% to 10% of the total weight of the lithium battery anode material, wherein the modification layer is a composite lithium metal oxide material represented by the chemical formula Li₄M₅O₁₂-MOₓ, wherein, M is Ti or Mn, and 1≦x≦2. The MOₓ in the above composite lithium metal oxide material is about, for example, 0.1% to 50% of the total weight of the modified material.

In one exemplary embodiment, the Li₄M₅O₁₂ in the above composite lithium metal oxide material is, for example, a spinel-type lithium titanium oxide material, and MOₓ is, for example, a metal suboxide, such as TiO, Ti₅O₉ or Ti₉O₁₇ or TiO₂, MnO, Mn₂O₃, MnO₂, etc. When the MOₓ in the composite lithium metal oxide is TiO₂ or MnO₂, the MOₓ is a polymorphous structure, such as an amorphous structure, a rutile structure, an anatase structure, a brookite structure, a bronze structure, a ramsdellite structure, a hollandite structure or a columbite structure. For example, the thickness of the modification layer 104 ranges between about 1 nm to about 500 nm, and the modification layer 104 could be a dense layer or a porous layer. The so-called porous layer implies a film layer having a porous structure and the pores are not formed by particles. The so-called dense layer refers to a material layer having a non-porous structure. The material of the carbon core 102 includes, for example, natural graphite, artificial graphite (such as, MCMB), carbon black, carbon nanotube or carbon fiber. The average particle size of the carbon core 102 is about 1 μm to about 30 μm.

In the one exemplary embodiment, the surface of the carbon core is modified to a layer of composite lithium metal oxide material. The carbon material, after being modified, retains the original characteristics of low potential and stable capacity, it also has large current charging capability.

The fabrication method of the above-mentioned lithium battery anode material 100 includes using a carbon material (such as, natural graphite, artificial graphite (such as, MCMB), carbon black, carbon nanotube or carbon fiber) to manufacture a core. Since the surface of the carbon core has several organic functional groups, such as carbonyl groups (C═O), carboxyl groups (C—OOH), hydroxyl groups (—OH), due to effect of chemical bonding, the lithium/titanium precursor (or lithium/manganese precursor) will commence a sol-gel reaction on the surface of the carbon core to form a chemical bond between the lithium/titanium precursor (or lithium/manganese precursor) and the surface of the carbon core. Further controlling the conditions of the calcining step, a composite lithium metal oxide/carbon composite material Li₄M₅O₁₂-MOₓ/C is formed. The above-mentioned lithium/titanium precursor includes, for example, titanium (IV) isopropoxide (TTIP), lithium acetate, titanium tetrachloride, etc. The above-mentioned lithium/manganese precursor includes, for example, manganese isopropoxide, manganese chloride, etc. The above-mentioned calcining step is performed at a temperature maintained between about, for example, 650° C. to 850° C. and for a time period of about 1 to 24 hours. The gases used in the calcining step, such as argon, hydrogen/argon (H₂/Ar), nitrogen (N₂), hydrogen/nitrogen (H₂/N₂) or air. Moreover, in order for the composite lithium metal oxide material to completely cover the surface of the carbon core, a wetting process may perform prior to the sol-gel reaction, such that the surface of the carbon core could become hydrophilic.

FIG. 2 is a schematic, cross-sectional view diagram illustrating another anode material of the lithium battery of the exemplary embodiment. Referring to FIG. 2, the lithium battery anode material 200, the carbon core 202 and the modification layer 204 are fundamentally the same in materials, dimensions and fabrication methods as the lithium battery anode material 10, the carbon core 102 and the modification layer 104 illustrated in FIG. 1. The modification layer 204 in this exemplary embodiment is, however, a particle-shaped layer inlayed in the surface of the carbon core 202. In other words, the coverage of the carbon core 202 by the modification layer 204 is more than about 60%, and less than 100%.

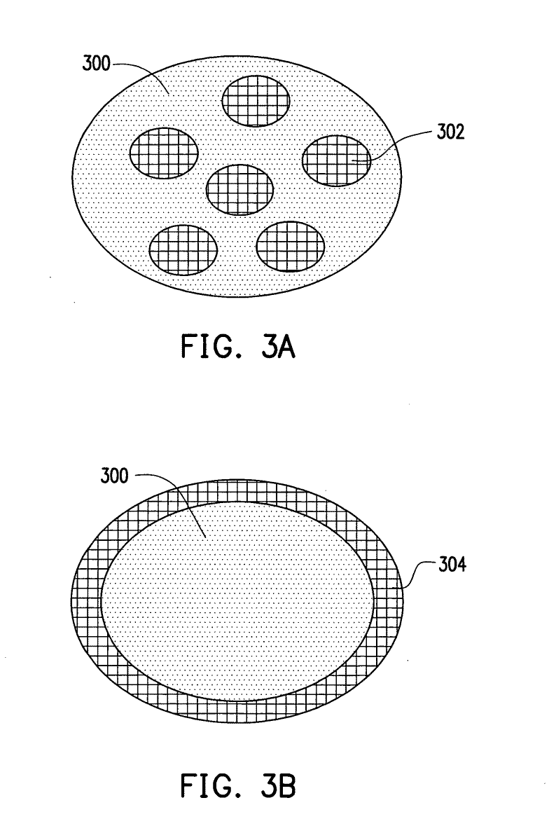

FIGS. 3A and 3B are schematic diagrams of the modification layer in the exemplary embodiment respectively. In the exemplary embodiment, MOₓ 302 in the composite lithium metal oxide material is doped in the Li₄M₅O₁₂ 300 crystal, as shown in FIG. 3A; or MOₓ 304 completely covers the surface of Li₄M₅O₁₂ 300, as shown in FIG. 3B. Accordingly, a chemical reaction occurring directly on the surface of the carbon core due to the decomposition of the electrolyte can be avoided and the generation of the SEI film can be precluded. Hence, during the charging/discharging of the battery, the generation of a SEI film is suppressed to obviate an increase of the internal resistance of the anode material. The diffusion route and the electron conduction capability of lithium ions are improved, allowing lithium ions to rapidly channel through the lithium metal oxide material and enter the carbon material. Hence, a high current charging capability is achieved. For example, in the exemplary embodiment, when lithium is used as a reference electrode, the average working potential of the anode material of the lithium battery is between about 1 mV to about 0.5 V.

Several experimental results are discussed below to demonstrate the effect of the anode material of the exemplary embodiments in the disclosure.

### Experiment 1

### Preparation of an Anode Material Having a Composite Lithium Titanium Oxide Modification Layer for a Lithium Battery

Firstly, 2 g of titanium (IV) isopropoxide (TTIP, C₁₂H₂₈O₄Ti, M=284.26) and 0.37 g of lithium acetate (C₂H₃LiO₂, M=65.99) are dissolved and mixed in dry alcohol, wherein the molar ratio of TTIP and lithium acetate is 5:4.

After stirring the solution for 30 minutes, the solution is heated to 80° C. and the stirring is continued for 2 hours.

Then, about 20 g of acid-treated mesocarbon micro beads is added to the solution and the solution is stirred at 80° C. until it becomes a gel. According to the reaction formula C₁₂H₂₈O₄Ti (TTIP)+C₂H₃LiO₂→Li₄Ti₅O₁₂+TiO₂+C₃H₇OH, the final weight of lithium titanium oxide/the weight of MCMB is about 3%.

Thereafter, the resultant is vacuum-dried at 85° C. for 5 hours, followed by calcining at 800° C. for about 10 hours under an argon gas.

### Experiment 2

### Preparation of a Lithium Battery

The preparation of an anode plate: The lithium battery anode material obtained from Experiment 1 and a hydrophilic acrylic adhesive (LA132) at a weight ratio of 92:8 are prepared. A specific ratio of deionized water is added to the mixture and the resultant is evenly mixed to form slurry. The slurry is then coated on a copper foil (14 μm to 15 μm) using a 120 μm blade. Hot air drying followed by vacuum drying is subsequently performed to remove the solvent and to obtain an electrode plate.

Preparation of Battery: Prior to assembling a battery, the above electrode plate is compressed and punched to form a coin-type electrode plate with a diameter of 13 mm. A lithium battery is assembled by applying lithium as a cathode and 1M of LiPF₆-EC/PC/EMC/DMC (3:1:4:2 by volume)+2 wt % VC as an electrolyte and by combining the above coin-type electrode plate.

### Comparative Example

Commercialized graphite MCMB1028 (provided by Osaka Gas Co.) is used as a comparative example.

### Testing

The electrical characteristics of a battery prepared as those of Experiment 1, Experiment 2 and the comparative example are evaluated in a charge/discharge range of about 5 mV to 2.0 V, and at a charge/discharge rate of 0.05 C, 0.5 C, 1 C, 2 C, 4 C, and 6 C.

### Result 1

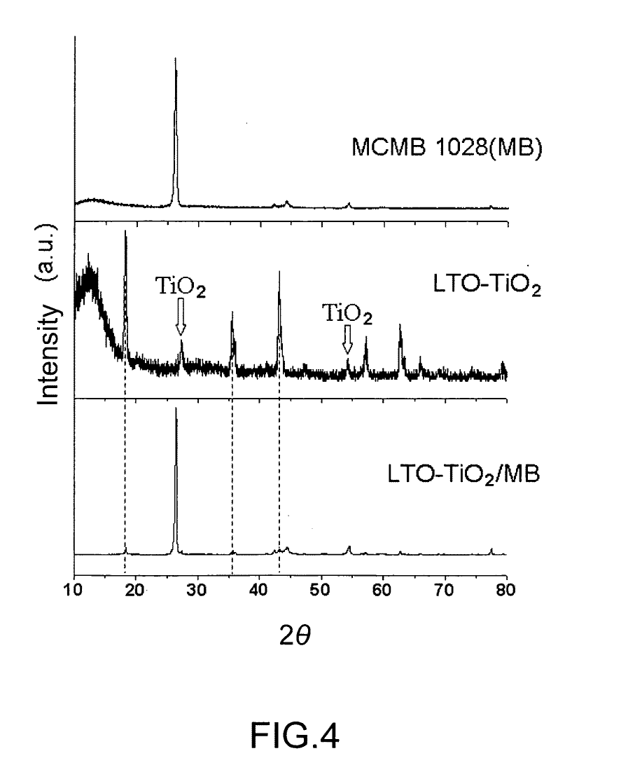

FIG. 4 is a graph showing the differences in powder X-ray diffraction characteristics of MCMB powers before and after being modified. The major diffraction peak position 2θ is 26.22, which belongs to (002) diffractive surface and has a layered structure. The lithium titanium oxide material (Li₄Ti₅O₁₂, LTO)—TiO₂ is obtained by using titanium(IV) isopropoxide (TTIP) and lithium acetate as the precursor, and by applying the same method of sol-gel reaction in Experiment 1 and calcining at 800° C.

The LTO diffraction signal of LTO—TiO₂ in FIG. 4 is compatible with the JCPDS (No. 226-1198) standard card, indicating the composite lithium titanium oxide material has a face-centered cubic structure (Fd-3m). Moreover, a weak diffraction signal appears at 20 being 27.32 and 54.24. Comparing with the JCPDS (no. 26-1198) standard card, a rutile TiO₂ structure (P4/mnm) is confirmed.

An X-ray diffraction experiment is performed on the lithium-ion battery anode material (LTO—TiO₂/MB) as prepared in Experiment 1, wherein the lithium battery anode material includes a composite lithium titanium oxide material modification layer. Based on the LTO—TiO₂/MB powder X-ray diffraction graph, a weak LTO diffraction signal is identified as the spinel structure of a lithium titanium oxide material and a strong MCMB diffraction signal is identified as the layered structure. Moreover, a partially doped TiO₂ (rutile) forming the crystalline LTO—TiO₂/MCMB composite material is also identified.

### Result 2

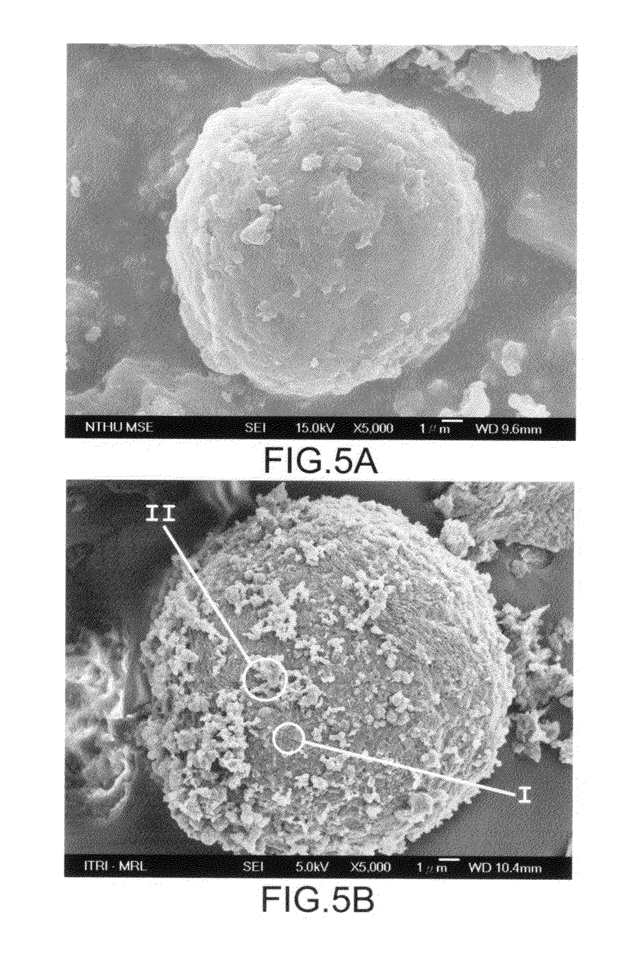

FIG. 5A is a SEM photograph showing the surface appearance of the mesocarbon micro beads (MCMB) prior to being modified (MCMB 1028). The MCMB is shown to be a spherical shaped particle, and the particle size is about 10 μm.

FIG. 5B is a SEM photograph showing the surface appearance of MCMB after being modified, which is the LTO—TiO₂/MCBC composite material of Experiment 1. In FIG. 5B, the surface of the modified MCMB is covered with LTO crystalline particles to form a core-shell appearance, and the grain size could reach the nanometer level (80 nm to 200 nm).

Thereafter, energy dispersive spectrometer (EDS) analysis is applied to determine the element distribution, as shown by the two Points I and II in FIG. 5B. The point I position is the surface of the original MCMB, and the EDS analysis shows there is only the carbon and oxygen elements, indicating that only carbon is present when the structural design of the core is carbon. The point II position is a LTO—TiO₂ shell, and the carbon, oxygen and titanium elements are concurrently present. These results demonstrate that after the MCMB is modified, a LTO—TiO₂/MCMB composite material with a core-shell structure is formed.

### Result 3

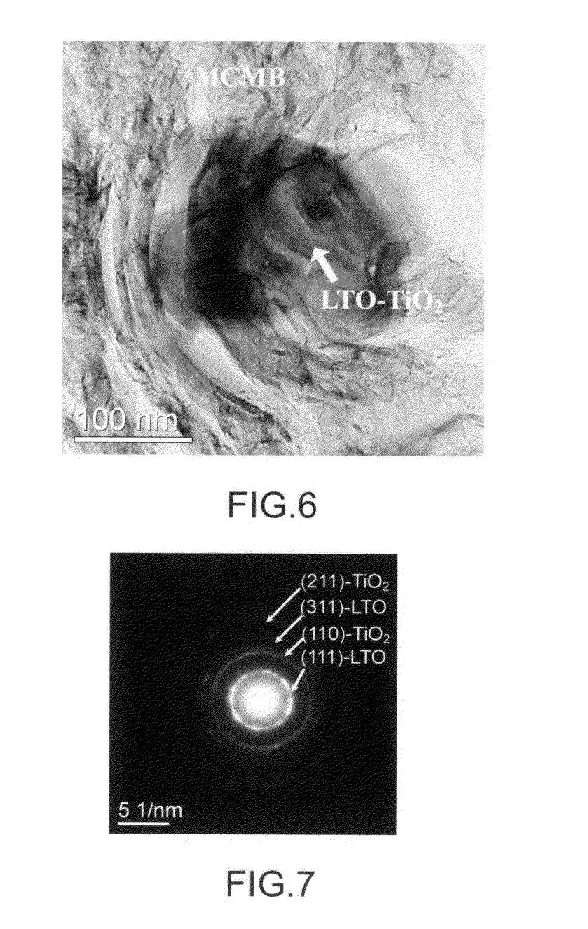

FIG. 6 shows the result of a TEM microstructure analysis of the LTO—TiO₂/MCBC composite material of Experiment 1, wherein the LTO—TiO₂/MCBC composite material powders are wrapped and sliced to form a TEM sample. FIG. 6 demonstrates the LTO—TiO₂ crystals are tightly connected to the MCMB, and some of the LTO—TiO₂ crystals are embedded in the surface of the MCMB to form a single composite. Moreover, no phase separation is observed. FIG. 7 illustrates the result of a selected area electron diffraction (SAED) analysis on the LTO—TiO₂ crystals. As shown in FIG. 7, there are many diffraction rings, which are respectively the LTO (111) and (311) diffractive surfaces, indicating the LTO—TiO₂ crystals are polycrystal LTO nano-crystal. Moreover, (110) and (211) electron diffraction rings respectively appear for the LTO crystals doped with a small amount of TiO₂ (rutile). These results are consistent with the data of the powder X-ray diffraction.

### Result 4

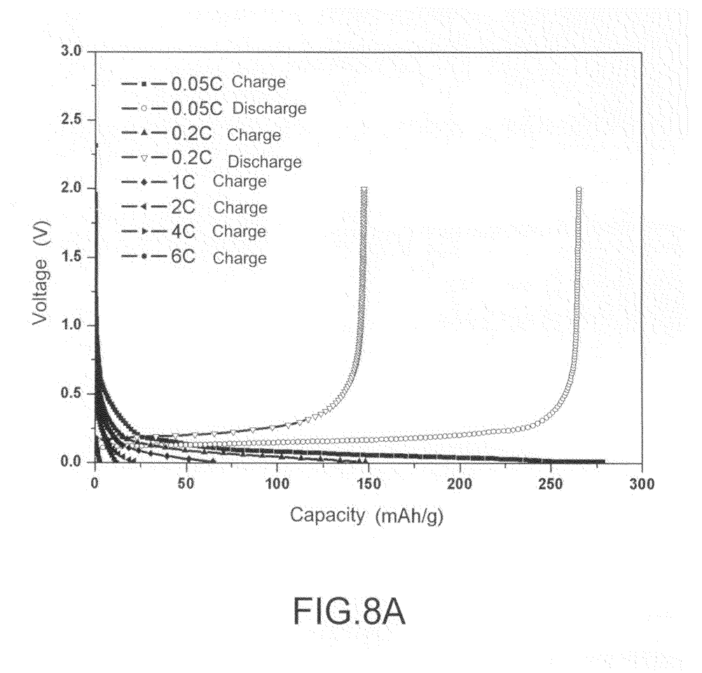

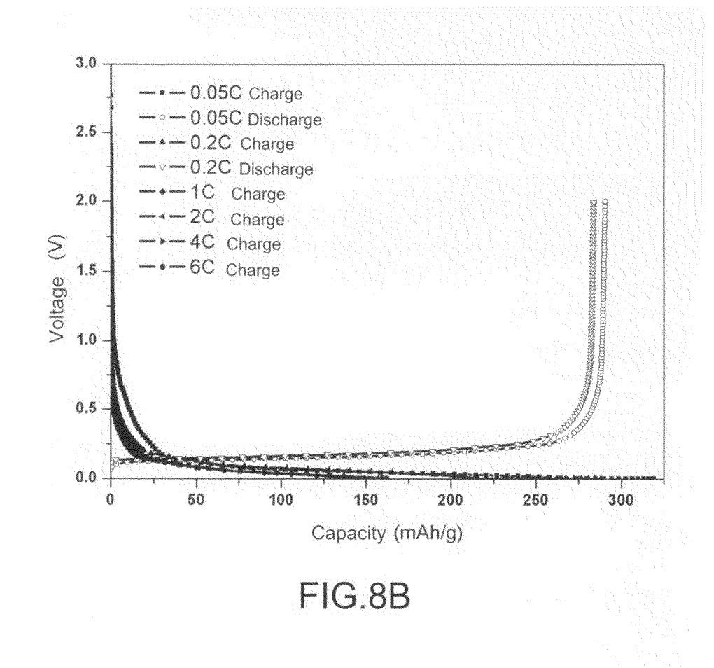

FIGS. 8A and 8B are graphs showing the charging and discharging curves of the comparative example (non-modified MCMB) and the sample of Experiment 2 (modified MCMB), respectively.

In FIG. 8A, MCMB 1028 (theoretical capacity of about 310-320 mAh/g) performs a first charge/discharge at a current rate of 0.05 C. The charging capacity is about 280 mAh/g, the discharging capacity is 258 mAh/g (conductive substance is not added in the electrode), the irreversible capacity is 22 mAh/g, and the reversible efficiency is 92%. When charging with different current rates and discharging with the same current rate, the intercalation and deintercalation reactions occur at 0.2V to 0.3V, and at the 0.2 times of charging rate (0.2 C), the charging capacity is 158 mAh/g, which is 44% less than the original capacity (258 mAh/g). At the 4 times of charging rate (4 C), the charging capacity is 13 mAh/g; even when the charging rate reaches 6 C, the charging capacity remains only 4 mAh/g. The maintain rate (4 C/0.2 C) of MCMB 1028 is only 8%. The main reason is because MCMB is a graphite material, and by nature, the electrolyte easily reacts with the surface of graphite to formation a SEI film, and electrode polarization phenomenon occurs. Hence, lithium ions do not easily enter into the interior of the graphite. As a result, graphite is not a desirable material for high current rapid charging.

FIG. 8B is a graph showing the result of a first charging and discharging of the lithium battery of Experiment 2 at a rate of 0.05 C, wherein the charging capacity is 313 mAh/g, while the discharging capacity is 285 mAh/g, the irreversible capacity is 27 mAh/g, reversible efficiency is 91%. At the charging rate of 0.2 C, the charging capacity is 282 mAh/g, which is only 10% less than the original capacity. When the charging rate reaches 4 C, the charging capacity still has 186 mAh/g, which is about 15 times of that of the original MCMB. When the charging rate reaches 6 C, the charging capacity still has 162 mAh/g, the maintain rate can be as high as 58%.

### Result 5

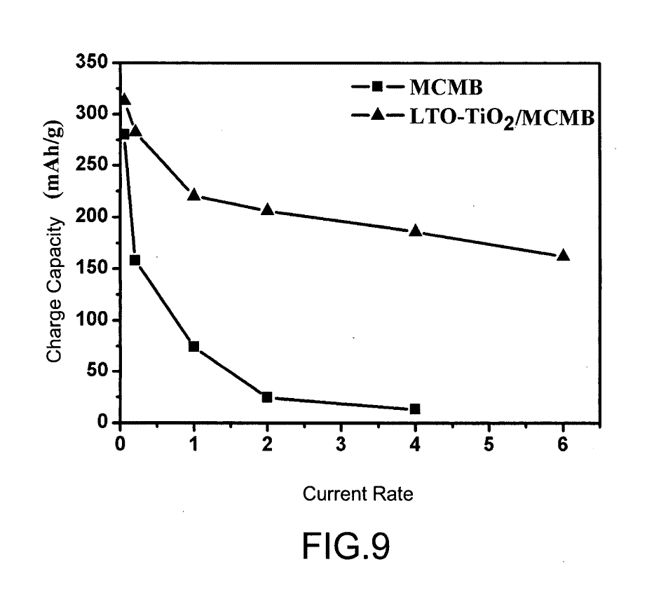

FIG. 9 is a graph showing the differences in capacity between the comparative example (non-modified MCMB) and the sample of Experiment 1 (post-modified MCMB) under different current rates (C-rate). When the pre-modified MCMB is charged at 0.05 C, 0.2 C, 1 C, 2 C, 4 C, 6 C, the capacity is 280 mAh/g, 158 mAh/g, 74 mAh/g, 25 mAh/g, 13 mAh/g and 4 mAh/g, respectively. When the post-modified MCMB is charged at 0.05 C, 0.2 C, 0.05 C, 1 C, 2 C, 4 C, 6 C, the capacity is 313 mAh/g, 282 mAh/g, 270 mAh/g, 220 mAh/g, 206 mAh/g, 186 mAh/g and 182 mAh/g, respectively. These results indicate that the surface of MCMB includes a composite lithium titanium oxide (LTO—TiO₂) modification layer, which could reduce the generation of a SEI film on the MCMB surface. Further, LTO oxide material doped with titanium dioxide (TiO₂) nanoparticles has a spinel structure, which facilitates the moving in and out of lithium ions during the charging and discharging. Hence, the chances that lithium ions moving in and out increases to ensure that the lithium ions take a shortened route to enter the graphite material and all the lithium ions diffuse in the shortest diffusion time. Accordingly, the modified graphite material is favorable to high current charging.

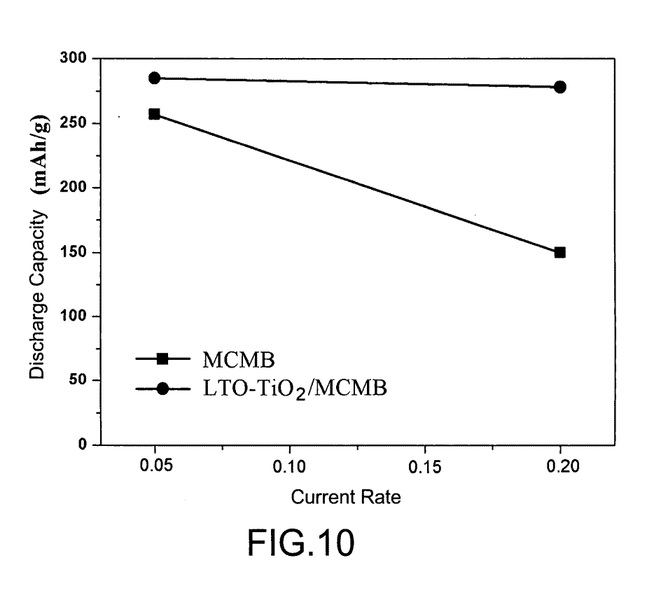

FIG. 10 is a graph showing the difference in capacity between the modified MCMB battery and the non-modified MCMB battery under different discharging current rates. As shown in FIG. 10, when the non-modified MCMB battery discharges at 0.05 C and 0.2 C, the capacity is about 260 mAh/g and about 150 mAh/g, respectively. When the modified MCMB battery discharges at 0.05 C and 0.20 C, the capacity is about 280 mAh/g and about 275 mAh/g, respectively. These results indicate that when the modified MCMB discharges at a high current rate, the maintain rate (0.20 C/0.05 C) is about 98%, while the maintain rate (0.20 C/0.05 C) of the pure MCMB (non-modified) is about 58%. Accordingly, the discharge characteristic (0.20 C/0.05 C) of the lithium battery formed with the composite lithium titanium oxide material/carbon composite material of Experiment 1 is more than twice of that of the pure lithium titanium oxide material/carbon composite material.

### Result 6

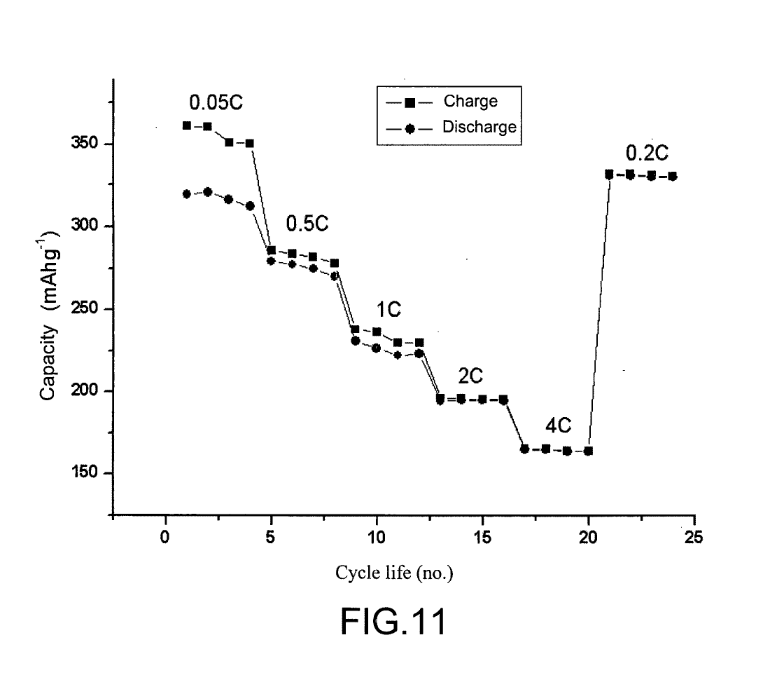

FIG. 11 is a graph showing the cycle life of the lithium battery of Experiment 2 under different charging and discharging current rates, wherein the battery includes an anode material and the anode material includes the MCMB of Experiment 1 and the surface of the MCMB includes a composite lithium titanium oxide LTO—TiO₂ modification layer. As shown in FIG. 11, the capacity of the modified MCMB correspondingly decreases as the current rate gradually increases from 0.05 C to 4 C. However, when the current rate returns from 4 C to 0.2 C directly, the discharging capacity maintains at about 330 mAh/g. These results indicate that after charging and discharging for several dozen times, the modified MCMB still maintains its efficiency.

According to the exemplary embodiments in the disclosure, a sol-gel method is applied to modify the carbon surface to a layer of Li₄M₅O₁₂-MOₓ (1≦x≦2, M=Ti or Mn) composite lithium metal oxide. As a result, the formation of a solid electrolyte interface is suppressed and lithium ions are allowed to expeditiously enter the carbon material through the above composite lithium metal oxide. Rapid charging is thereby achieved. The metal oxide (MOₓ) may be metal suboxide and thus the conductivity of lithium metal oxide can be enhanced, and the graphite of the anode material with low potential and stable capacity may also have a high current charging capability. The charging capacity of the anode material of the exemplary embodiments in the disclosure maintains above 160 mAh/g under the charging condition of 0.2 C to 6 C.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An anode material of a lithium battery, the anode material comprising:
a carbon core; and
a modification layer, configured on a surface of the carbon core via a sol-gel method, wherein the modification layer is a composite lithium metal oxide material represented by a formula Li₄M₅O₁₂-MOₓ, wherein M represents titanium or manganese, and 1≦x≦2.

2. The anode material of claim 1, wherein when lithium is used as a reference electrode, an average work function of the lithium battery anode material is between 1 mV and 0.5V.

3. The anode material of claim 1, wherein a thickness of the modification layer is about 1 nm to about 500 nm.

4. The anode material of claim 1, wherein the Li₄M₅O₁₂ in the composite lithium metal oxide material is a spinel-type lithium oxide material.

5. The anode material of claim 1, wherein the MOₓ in the composite lithium metal oxide material comprises the MOₓ doped in the Li₄M₅O₁₂ or the MOₓ covering the surface of the Li₄M₅O₁₂.

6. The anode material of claim 1, wherein the MOₓ in the composite lithium metal oxide material comprises TiO, Ti₅O₉, TiO₉O₁₇, TiO₂, MnO, Mn₂O₃, or MnO₂.

7. The anode material of claim 6, wherein when the MOₓ in the composite lithium metal oxide material comprises TiO₂ or MnO₂, and the MOₓ is a polymorphous structure.

8. The anode material of claim 7, wherein the polymorphous structure includes an amorphous structure, a rutile structure, an anatase structure, a brookite structure, a bronze structure, a ramsdellite structure, a hollandite structure or a columbite structure.

9. The anode material of claim 1, wherein the modification layer includes a dense layer or a porous layer.

10. The anode material of claim 1, wherein the modification layer is a thin film layer or a particle shape layer inlayed in the surface of the carbon core.

11. The anode material of claim 1, wherein there is a bond between the modification layer and the carbon core, wherein the modification layer covers more than 60% of the carbon core.

12. The anode material of claim 1, wherein the MOₓ in the composite lithium metal oxide material is about 0.1% to 50% of a total weight of the modification layer.

13. The anode material of claim 1, wherein a content of the modification layer is about 0.1% to 10% of a total weight of the anode material of the lithium battery.

14. The anode material of claim 1, wherein a material of the carbon core material comprises natural graphite, artificial graphite, carbon black, nanotube or carbon fiber.

15. The anode material of claim 1, wherein an average diameter of the carbon core is about 1 μm to about 30 μm.

16. A method for fabricating an anode material of a lithium battery, the method comprising:
using a carbon material to fabricate a core;
using a sol-gel method to form a modification layer on a surface of the core, wherein the modification layer is a composite lithium metal oxide material represented by a formula Li₄M₅O₁₂-MOₓ, wherein M includes titanium or manganese, and 1≦x≦2; and
performing a calcining process.

17. The method of claim 16, wherein the calcining process is performed at a temperature of about 650° C. to about 850° C. for about 1 to 24 hours.

18. The method of claim 16, wherein a gas used in the calcining process comprises argon, hydrogen/argon (H₂/Ar), nitrogen, hydrogen/nitrogen (H₂/N₂) or air.
